(19) United States
(12) Patent Application Publication
(10) Pub. No.: US 2026/0076390 A1
(43) Pub. Date: Mar. 19, 2026

(54) Reusable Flavor-Dispensing Lollipop Device

(71) Applicant: Tammy Crossno, Pauline, SC (US)

(72) Inventor: Tammy Crossno, Pauline, SC (US)

(21) Appl. No.: 19/204,853

(22) Filed: May 12, 2025

Related U.S. Application Data
(60) Provisional application No. 63/696,520, filed on Sep. 19, 2024.

(51) Int. Cl. A23G 3/56; A47G 21/18

(52) U.S. Cl. CPC A23G 3/563; A47G 21/183

(57) ABSTRACT

The present invention relates to a reusable lollipop device that enables controlled dispensing of flavored gel. The device includes a hollow, elongated straw with a cavity for holding a flavored gel. A sucking head made of a durable and porous material is removably attached to the straw's top end and features miniature apertures for controlled gel release. The sucking head includes a straw-compatible hole to secure the top end of the straw, permitting the flavored gel to flow into the head when suction or pressure is applied. A method of using the device involves inserting a flavored gel-filled straw into the sucking head, sucking on the head to create a vacuum for gel release, and applying pressure to control the flow rate.

### CROSS-REFERENCE TO RELATED APPLICATION

The present application claims priority to, and the benefit of, U.S. Provisional Application No. 63/696,520, which was filed on Sep. 19, 2024, and is incorporated herein by reference in its entirety.

### FIELD OF THE INVENTION

The present invention generally relates to flavored lollipops. More specifically, the invention relates to a reusable lollipop device that allows users to control the dispensing of flavored gels. The device comprises a hollow straw with a cavity for holding flavored gel and a detachable, porous sucking head that regulates the flow of the gel through miniature apertures. The system enables user-controlled dispensing through suction or pressure on the straw, offers interchangeable flavor options, and is designed for easy cleaning and reuse. Accordingly, this disclosure makes specific reference thereto the present invention. Nonetheless, it is to be appreciated that aspects of the present invention are also equally applicable to other like applications, devices, and methods of manufacture.

### BACKGROUND

By way of background, lollipops and similar sucking devices are a popular and enjoyable treat for both children and adults. They offer a fun way to satisfy sweet cravings. However, conventional lollipops come with a number of challenges and potential risks, particularly for younger children. Infants and toddlers, especially those under the age of three, are at a heightened risk of choking when consuming traditional lollipops due to their size and solid nature.

In addition to safety concerns, the storage of lollipops presents its own set of problems. When not stored properly, lollipops can become stale, dry out, or develop an unpleasant, sticky texture, making them less enjoyable to consume. Moreover, many lollipops are individually wrapped in single-use packaging, contributing to waste and environmental concerns. Traditional lollipops dissolve passively, making it difficult for users to control the amount of sugar intake at any given time, potentially leading to excessive consumption. People desire an improved lollipop device that addresses these safety, storage, and health-related issues while still providing a satisfying and enjoyable experience for users of all ages.

Therefore, there exists a long-felt need in the art for a lollipop device that allows users to control the flavor dispensing process, thereby reducing health risks associated with excessive sugar consumption. There is a long-felt need for a lollipop that provides a safer alternative for young children. Additionally, there is a long-felt need for a lollipop device that can be reused and is designed to keep flavors fresh, eliminating the issues of staleness, drying out, or unpleasant textures found in conventional lollipops. Moreover, there is a long-felt need for a lollipop system that offers the ability to swap out flavors quickly, catering to users'varying preferences without producing excessive waste. Finally, there is a long-felt need for a device that offers a user-controlled dispensing method that allows individuals to regulate their sugar intake and enjoy the treat at their desired pace.

The subject matter disclosed and claimed herein, in one embodiment, comprises a flavored lollipop device designed to provide a user-controlled and safe flavor dispensing experience. The device includes a hollow, elongated straw that functions as a conduit for a flavored gel stored within the straw. The straw features a top end that is open for dispensing the gel and a bottom end that is closed to contain the gel within the cavity. A detachable sucking head is disposed on the top end of the straw, made from a durable, porous material with a plurality of miniature apertures that allow for the controlled release of the flavored gel. The sucking head serves as both a dispensing surface and a reservoir for the flavored gel, providing a customizable flow rate based on the user's preferences. The straw can be squeezed or twisted to speed up the release of the gel, and the entire device is designed to be washed and reused with different flavored straws.

In this manner, the flavored lollipop device of the present invention accomplishes all of the foregoing objectives, offering a safer, reusable, and customizable solution for enjoying a lollipop. The device provides an innovative way to control flavor release, minimizing sugar intake and reducing the risk of choking for younger users. The modular design allows users to interchange flavored straws, addressing individual taste preferences without the issues of staleness or drying out. The device's unique structure also provides a more hygienic and environmentally friendly option by allowing for cleaning and reuse.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a flavored lollipop device. The device comprises a hollow, elongated straw having a top end, a bottom end, and a cavity extending along its length, wherein the bottom end is closed, and the straw is configured to store a flavored gel or liquid therein. A sucking head is removably attached to the top end of the straw, wherein the sucking head is made from a porous material and includes a plurality of miniature apertures disposed in the outer surface thereof, enabling the flavored gel or liquid to be dispensed through the apertures when a vacuum is created inside the head by sucking. The sucking head includes a straw-compatible hole for securely accommodating the top end of the straw to allow the flavored gel or liquid to flow into the sucking head. The flavored lollipop device is configured to allow the user to selectively dispense the flavored gel or liquid by applying suction to the sucking head and by applying pressure on the straw.

In another aspect, a method of using a flavored lollipop device is disclosed. The method includes the steps of selecting a flavored gel-filled straw, the straw has a top end and a closed bottom end, and a cavity along a length thereof containing the flavored gel, inserting the top end of the straw into a straw-compatible hole of a sucking head made of a durable and porous material, the sucking head has a plurality of apertures for dispensing the flavored gel, sucking on the sucking head to create a vacuum inside the sucking head, thereby drawing the flavored gel from the straw into the sucking head and through the apertures, applying pressure to the straw to control the rate at which the flavored gel is dispensed from the sucking head, and removing and cleaning the sucking head after consumption of the flavored gel, allowing for the reuse of the lollipop device with different flavored straws.

In another embodiment, a flavored lollipop device for controlled dispensing of flavored gel is disclosed. The device comprises a hollow straw having a top end and a closed bottom end, the straw defining a cavity for holding a flavored gel, the gel being viscous enough to remain within the cavity until dispensed, a porous sucking head detachably secured to the top end of the straw, the sucking head having a plurality of apertures for dispensing the flavored gel, the apertures being adjustable to control the flow rate of the gel from inside the sucking head to an outer surface, wherein the sucking head includes a hole for securely accommodating the top end of the straw to enable the flavored gel to flow into the sucking head when suction or pressure is applied to the straw, allowing for user-controlled dispensing of the flavored gel.

In yet another aspect, the sucking head further comprises a plurality of internal chambers for holding different flavored gels, thereby allowing the user to dispense multiple flavor combinations through the plurality of apertures.

In still another aspect, the flavored gel is formulated to change flavor intensity based on the temperature of a user's mouth, providing an enhanced sensory experience during consumption.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of the flavored lollipop of the present invention in accordance with the disclosed structure;

FIG. 2 illustrates a flow chart depicting the use of the flavored and reusable lollipop of the present invention in accordance with the disclosed structure;

FIG. 3 illustrates a perspective view of the flavored lollipop device of the present invention with flavored gel or liquid dispensed from the lollipop head in accordance with the disclosed structure;

FIG. 4 illustrates a perspective view of a user sucking the flavored lollipop of the present invention in accordance with the disclosed structure;

FIG. 5 illustrates a perspective view of an exemplary flavored lollipop packaging in accordance with one embodiment of the present invention; and

FIG. 6 illustrates another embodiment of the porous head of the flavored lollipop device of the present invention in accordance with the disclosed structure.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a lollipop device that allows users to control the flavor dispensing process, thereby reducing health risks associated with excessive sugar consumption. There is a long-felt need for a lollipop that provides a safer alternative for young children. Additionally, there is a long-felt need for a lollipop device that can be reused and is designed to keep flavors fresh, eliminating the issues of staleness, drying out, or unpleasant textures found in conventional lollipops. Moreover, there is a long-felt need for a lollipop system that offers the ability to swap out flavors quickly, catering to users'varying preferences without producing excessive waste. Finally, there is a long-felt need for a device that offers a user-controlled dispensing method that allows individuals to regulate their sugar intake and enjoy the treat at their desired pace.

The present invention, in one exemplary embodiment, is a flavored lollipop device for the controlled dispensing of flavored gel. The device comprises a hollow straw having a top end and a closed bottom end, the straw defining a cavity for holding a flavored gel, the gel being viscous enough to remain within the cavity until dispensed, a porous sucking head detachably secured to the top end of the straw, the sucking head having a plurality of apertures for dispensing the flavored gel, the apertures being adjustable to control the flow rate of the gel from inside the sucking head to an outer surface, wherein the sucking head includes a hole for securely accommodating the top end of the straw to enable the flavored gel to flow into the sucking head when suction or pressure is applied to the straw, allowing for user-controlled dispensing of the flavored gel.

Reference will now be made in detail to the present preferred embodiments of the invention, examples of which are illustrated in the accompanying drawings. Wherever possible, the same reference numerals are used in the drawings and the description to refer to the same or like parts.

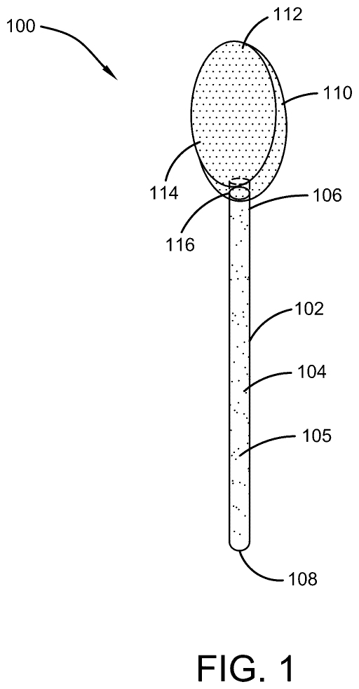

Referring initially to the drawings, FIG. 1 illustrates a perspective view of flavored lollipop 100 of the present invention in accordance with the disclosed structure. The flavored lollipop 100 of the present invention is designed to allow users to control the flavor dispensing process. Further, the modular lollipop system 100 can be reused and flavors can be swapped out as per the preferences of the users. More specifically, the reusable flavor-dispensing lollipop device 100 includes a straw 102 that can come in a variety of flavors. The straw 102 is hollow and elongated and includes a cavity 104 along the length thereof. The straw 102 functions as a conduit for a flavored gel or liquid 105 stored in the straw 102.

The straw 102 includes a top end 106 and an opposite bottom end 108, wherein the bottom end 108 is closed. The flavored gel 105 is viscous enough to not immediately leak out from the open top end 106 but fluid enough to be dispensed when pressure on the straw 102 is applied, as described later in the disclosure.

A sucking head 110 is disposed on the top end 106 of the straw 102 and is removably attached to the straw 102. The sucking head 110 is made from a durable and porous material and can be of any geometric shape. A plurality of miniature apertures 112 are disposed in the head 110 allowing for the flavor gel or liquid 105 to seep out from the head 110 slowly. During use, the sucking head 110 can be sucked by a user and the head 110 can also function as a reservoir of flavored gel or liquid 105 for storing the gel 105 therein. The size and number of apertures 112 can be adjusted to control the flow rate of the gel 105 from inside the head 110 to the outer surface 114 of the head 110.

In the preferred embodiment, the sucking head 110 includes a straw-compatible hole 116 to securely accommodate and secure the top end 106 of the straw 102 to the head 110. The top end 106 is secured inside hole 116, thereby allowing the gel 105 to flow into the sucking head 110. Unlike traditional suckers, where the candy dissolves passively, the lollipop device 100 allows users to control the rate at which the flavor is released and can have a prolonged experience or increase the suction or pressure on the stick to speed up the release of the gel 105. Once the flavored gel or liquid 105 is consumed, a user can remove the stick 102 and clean the sucking head 110.

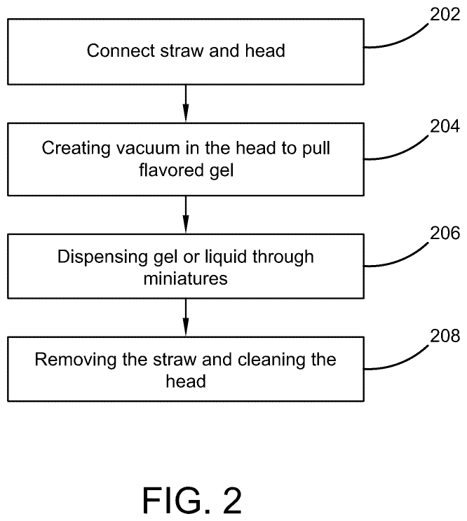

FIG. 2 illustrates a flow chart depicting a method of use of the flavored and reusable lollipop 100 of the present invention in accordance with the disclosed structure. Initially, a user selects a flavored gel or liquid-filled straw 102 and inserts the top end 106 thereof into the hole 116 of the head 110 (Step 202). The stick 102 connects securely to the hole 116 to enable the gel or liquid to flow properly into the dispensing head 110. Then, the user sucks on the porous head 110 and a vacuum is created inside the head 110, which pulls the flavored gel or liquid 105 through the stick 102 into the head 110 (Step 204). The pressure from sucking causes the gel or liquid to dispense slowly through the miniature holes 112 of the head 110 (Step 206). The user can apply pressure on the stick 102 by squeezing or twisting the stick 102 to force the gel or liquid 105 out more quickly. Finally, once the flavored gel or liquid is consumed, the user can remove the stick and clean the top head 110 and the device 100 can be refilled with a new flavored gel stick (Step 208).

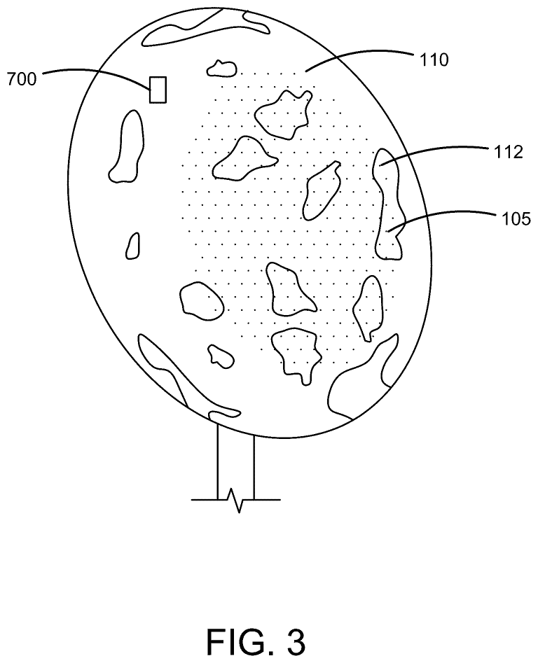

FIG. 3 illustrates a perspective view of the flavored lollipop device 100 of the present invention with flavored gel or liquid dispensed from the lollipop head in accordance with the disclosed structure. As illustrated, the flavored gel 105 is dispensed uniformly from the apertures 112 to provide a uniform experience to a user. The head 110 can be of different shapes such as heart, star, or animal shapes, enhancing the appeal of the reusable flavor-dispensing lollipop device 100 to children. In one embodiment, the head shape corresponds to the flavor of the flavored gel. The head 110 can also have a personalized engraving 700 thereon.

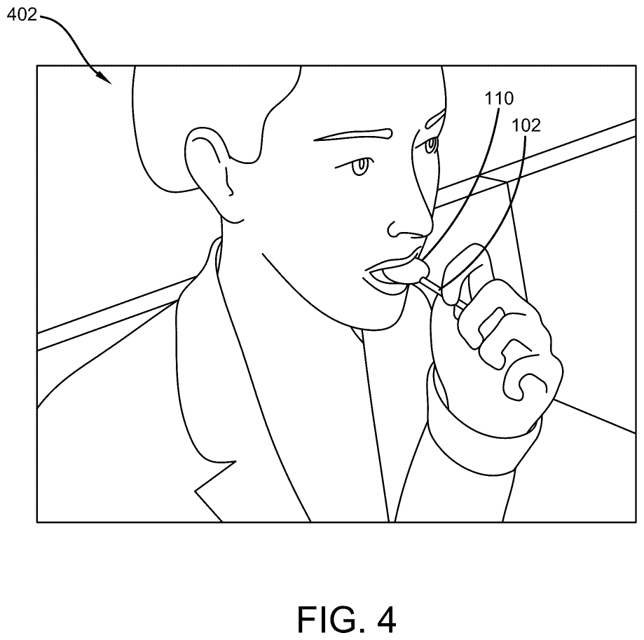

FIG. 4 illustrates a perspective view of a user sucking the flavored lollipop of the present invention in accordance with the disclosed structure. As illustrated, the user 402 uses the modular lollipop system 100 like any conventional lollipop device. During sucking the flavored lollipop 100, the user 402 sucks the head 110 to create a vacuum inside the porous head 110 to dispense the liquid and further, presses the straw 102 to increase the dispensing of the liquid from the aperture 112.

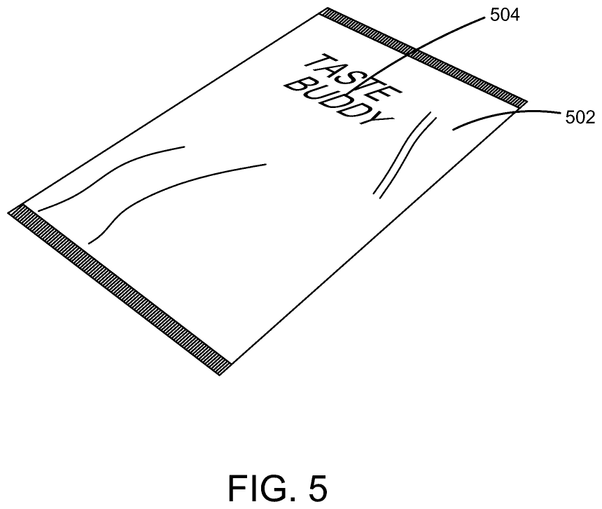

FIG. 5 illustrates a perspective view of an exemplary flavored lollipop packaging in accordance with one embodiment of the present invention. The flavored lollipop 100 of the present invention can come in different customized packages 502 with the packaging including detached straws 102 and heads 110 of different flavors and shapes. The packaging 502 may include a logo or indicia 504 for branding and marketing purposes.

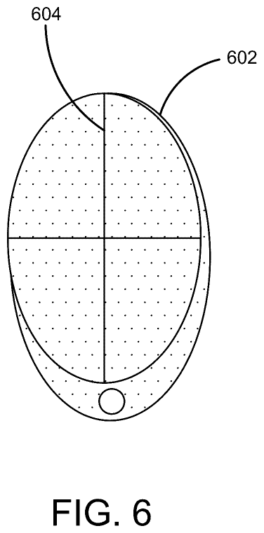

FIG. 6 illustrates another embodiment of the porous head of the flavored lollipop device of the present invention in accordance with the disclosed structure. In the present embodiment, the head 602 includes a plurality of chambers 604 disposed therein for holding different flavored gels. The chambers 604 provides multiple flavor combinations to the users for an enhanced experience.

In some embodiments, a unique flavored gel 105 that responds to external stimuli such as heat or moisture is used. The gel 105 is adapted to change flavor intensity based on the temperature of a user's mouth or dissolve faster when exposed to saliva. In one embodiment, cartridges with different viscosities and flavor intensities can be positioned inside the straw 102.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “reusable flavor-dispensing lollipop device”, “flavored lollipop device”, “lollipop device”, “modular lollipop system”, and “lollipop” are interchangeable and refer to the reusable flavor-dispensing lollipop device 100 of the present invention.

Notwithstanding the foregoing, the reusable flavor-dispensing lollipop device 100 of the present invention can be of any suitable size and configuration as is known in the art without affecting the overall concept of the invention, provided that it accomplishes the above-stated objectives. One of ordinary skill in the art will appreciate that the reusable flavor-dispensing lollipop device 100 as shown in the FIGS. are for illustrative purposes only, and that many other sizes and shapes of the reusable flavor-dispensing lollipop device 100 are well within the scope of the present disclosure. Although the dimensions of the reusable flavor-dispensing lollipop device 100 are important design parameters for user convenience, the reusable flavor-dispensing lollipop device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A flavored lollipop device comprising:
a straw comprised of a top end and a bottom end, wherein the bottom end is closed and the top end is open, the straw comprised of a cavity configured to store a gel or a liquid; and
a sucking head, the sucking head comprising a porous material and an aperture therein, the aperture allowing the flavored gel or the flavored liquid to be dispensed from the sucking head during use.

2. The flavored lollipop device of claim 1, wherein the sucking head is comprised of a straw-compatible hole.

3. The flavored lollipop device of claim 2, wherein the straw is positioned within the straw-compatible hole.

4. The flavored lollipop device of claim 1, wherein the straw is comprised of a hollow straw.

5. The flavored lollipop device of claim 1, wherein the straw is comprised of a cavity.

6. The flavored lollipop device of claim 1, wherein the flavored gel is comprised of a viscous gel.

7. The flavored lollipop device of claim 1, wherein the sucking head is removably attached to the top end of the straw.

8. The flavored lollipop device of claim 1, wherein the gel is comprised of a flavored gel.

9. The flavored lollipop device of claim 1, wherein the liquid is comprised of a flavored liquid.

10. The flavored lollipop device of claim 1, wherein the sucking head is comprised of a geometric shape.

11. The flavored lollipop device of claim 1, wherein the sucking head is comprised of an engraving.

12. A flavored lollipop device comprising:
a hollow, elongated straw comprised of a cavity for storing a flavored gel or a flavored liquid, and a closed bottom end and an open top end; and
a sucking head removably secured to the open top end of the straw, the sucking head comprising a plurality of apertures to allow the flavored gel or the flavored liquid to flow through during use.

13. The flavored lollipop device of claim 12, wherein the hollow, elongated straw is comprised of a reusable material.

14. The flavored lollipop device of claim 12, wherein the sucking head is comprised of a reusable material.

15. A method of using a flavored lollipop device, the method comprising the following steps:
inserting a flavored gel-filled straw into a sucking head comprised of an aperture;
sucking on the sucking head to create a vacuum, thereby drawing the flavored gel from the flavored gel-filled straw into the sucking head and dispensing the flavored gel through the aperture;
applying pressure on the flavored gel-filled straw to increase the flow of the flavored gel through the apertures; and
removing the flavored gel-filled straw and cleaning the sucking head after the flavored gel is consumed.

16. The method of using a flavored lollipop device of claim 15 further comprised of a step of twisting or squeezing the flavored gel-filled straw to force the flavored gel to flow more quickly into the head.

17. The method of using a flavored lollipop device of claim 15 further comprised of a step of refilling the straw with a new flavored gel.

18. The method of using a flavored lollipop device of claim 15 further comprised of a step of cleaning the sucking head.

19. The method of using a flavored lollipop device of claim 18, wherein the sucking head is cleaned when the flavored gel is consumed.

20. The method of using a flavored lollipop device of claim 19, wherein the flavored gel is comprised of a viscous gel.
